(19) United States
(12) Patent Application Publication
(10) Pub. No.: US 2002/0002409 A1
(43) Pub. Date: Jan. 3, 2002

(54) Product control method using wireless communication

(75) Inventor: Koji Eguchi, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/732,926

(22) Filed: Dec. 11, 2000

(30) Foreign Application Priority Data
May 31, 2000 (JP) 2000-162169 (P)

(51) Int. Cl. G06F 19/00; G05B 15/00

(52) U.S. Cl. 700/65; 700/83; 700/95; 700/100; 700/116

(57) ABSTRACT

A product controlling method that enables the operator to easily recognize an order of operation includes the steps of: transmitting a number can uniquely identifies portable telephone 200 such as a telephone number and inquiry data to a host computer when an inquiry button of a portable telephone attached to the product is pressed; receiving response data from the host computer; displaying data representing the following process of the received response data as well as data representing the process condition of the following process; and transmitting data representing the process condition of the following process to a production facility in the following process.

### BACKGROUND OF THE INVENTION

1. Field of the Invention

The present invention relates to a technique for controlling products produced in a factory and, more specifically, to a technique for controlling product information such as an order of plurality of operation processes, an operation condition, and a result of an operation by wireless communication.

2. Description of the Background Art

The products produced by a plurality of operation processes are controlled for example in the following manner. An LAN (Local Area Network) is provided in a factory with a production facility. Connected to the LAN are a computer controlling the products on a lot basis and a terminal device including an input circuit and a display circuit. When the operation at the production facility is completed, the operator inputs process completion information corresponding to a lot number of the completed products. The input process completion information is stored in the computer via LAN. When the operator inputs the lot number of the products into the input circuit in another terminal device, the operation condition of the following process is displayed for the products corresponding to the input lot number.

However, such a product control method merely controls data in accordance with the lot number of the products and displays the operation condition when the lot number is input. If the terminal device is not provided well close to the production facility, the operator must write down the operation condition or the like, which is displayed on the display circuit of the terminal device, for input to the production facility. Further, it is difficult to find a specific product in a factory where a large number of products are being produced at the same time.

### SUMMARY OF THE INVENTION

An object of the present invention is to provide a product control method enabling the operator to easily control a process of a product in a production process.

Another object of the present invention is to provide a product control method enabling the operator to easily recognize the following process of a product in a production process.

Still another object of the present invention is to provide a product control method enabling the operator to easily set a process condition in a production facility.

Still another object of the present invention is to provide a product control method enabling the operator to easily recognize result of an operation in the preceding process.

Still another object of the present invention is to provide a product control method enabling the operator to easily find a desired product in a production process.

The product control method according to the present invention controls production of products by wireless communication between a communication device performing wireless communication attached to a product and a computer controlling a process of producing products. The method includes steps of: preparing in a computer a control table storing control data for product control corresponding to an identification number for identifying the communication device; transmitting from the communication device to the computer the identification number and control data request information by wireless communication; transmitting from the computer to the communication device identified by the identification number the control data stored in the control table corresponding to the received identification number in response to the reception of the identification number and control data request information from the communication device; and receiving in the communication device the control data from the computer and outputting the control data related to the product in a form recognizable to a person based on the received control data.

The communication device transmits the identification number and control data request information to the computer. In response to the reception of the identification number and control data request information by the computer, the control data stored in the control table corresponding to the received identification number is transmitted to the communication device identified by the identification number. The communication device outputs the control data related to the product in a form recognizable to a person based on the control data received from the computer. Thus, the communication device such as a portable telephone is attached to the product and the control data controlled by the computer is displayed on a display portion of the portable telephone by communication between the portable telephone and computer.

More preferably, the control data includes progress chasing information on the product in the production process and process condition data of a production process. The step of outputting the control data includes a step of outputting the process condition data of the following step in a form recognizable to a person by the communication device.

The progress chasing information and process condition of the production process can be displayed on the display portion of the communication device such as the portable telephone attached to the product.

More preferably, the method further includes a step of transmitting the process condition data from the communication device to the production facility for producing products by wireless communication.

The process condition data received by the portable telephone can be transmitted to the production facility by communication between the computer and the communication device such as the portable telephone attached to the product.

More preferably, the control data includes operation result information on each production process, and the step of outputting the control data includes a step of outputting operation result information on the product in a form recognizable to a person by the communication device.

The operation result information on each production process transmitted from the computer can be displayed on the display portion of the communication device such as the portable telephone by communication between the computer and the portable telephone attached to the product.

The production control method of the present invention controls production of products by wireless communication between a communication device performing wireless communication attached to a product and a computer controlling a process of producing a product. The method includes the steps of: preparing in the computer registration data of the product corresponding to an identification number for identifying the communication device; selecting the product stored in the registration data; transmitting calling data to the communication device identified by the identification number corresponding to the product selected in the step of selecting the product; and performing a prescribed operation in the communication device identified by the calling data based on the received calling data in response to the reception of the calling data from the computer.

The computer transmits the calling data to the communication device identified by the identification number corresponding to the product selected in the selecting step. The communication device identified by the calling data performs a prescribed operation based on the received calling data in response to the reception of the calling data from the computer. For example, the communication device such as the portable telephone is attached to the product and ringing tones of the portable telephone are generated upon reception of the calling data, so that the operator can easily find a desired product in the production process.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overall structure of a process control system.

FIG. 2 is a block diagram showing hardware of a process controlling host computer.

FIG. 3 is a diagram showing a progress chasing control table controlled by the process controlling host computer.

FIGS. 4 to 8 are diagrams showing operation processes of products.

FIG. 9 is a block diagram showing hardware of a portable telephone.

FIG. 10 is a block diagram showing hardware of an input/output portion of the portable telephone.

FIG. 11 is a flow chart showing a control flow of an inquiry process in the portable telephone.

FIG. 12 is a flow chart showing a control flow of a responsing process in the host computer.

FIG. 13 is a flow chart showing a control flow of completing process in the portable telephone.

FIG. 14 is a flow chart showing a control flow of a progress chasing updating process in the host computer.

FIG. 15 is a flow chart showing a control flow of a calling process in the portable telephone.

FIGS. 16 and 17 are diagrams showing exemplary display screens of the portable telephone.

FIG. 18 is a diagram showing data transmitted between the portable telephone and the host computer.

### DESCRIPTION OF THE PREFERRED EMBODIMENTS

Now, the embodiment of the present invention will be described with reference to the drawings. The same reference numerals represent the same parts in the following description and throughout the drawings. The names and functions are also the same, and therefore detailed description thereof will not be repeated.

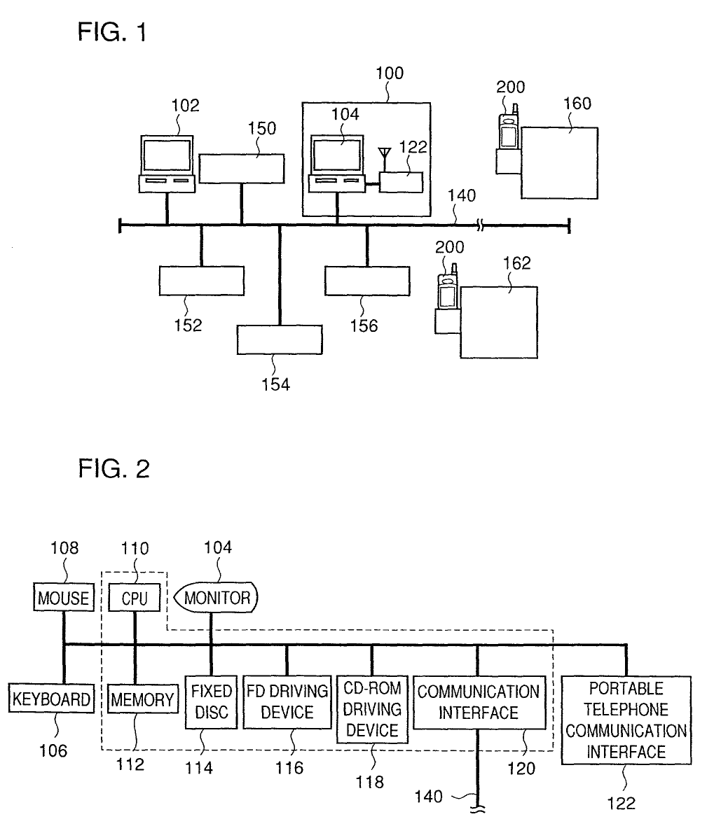

Referring to FIG. 1, a process control system using a portable telephone 200 according to the present invention includes: a plurality of portable telephones 200; a process controlling host computer 100 with a portable telephone communication interface 122; an operation result inputting computer 102; and a network 140 interconnecting process controlling host computer 100, an operation result inputting computer 102, and production facilities 150 to 156. It is noted that a plurality of production facilities are provided for a given operation in the operation process.

The process control system performs process control using portable telephone 200 attached to every lot with a plurality of products of the same production number. Portable telephone 200 may be a usual portable telephone, or may include a portion communicating with the production facility, bar code reading portion and camera, as will later be described. Further, a facility is provided for charging a rechargeable battery of portable telephone 200 not attached to the product.

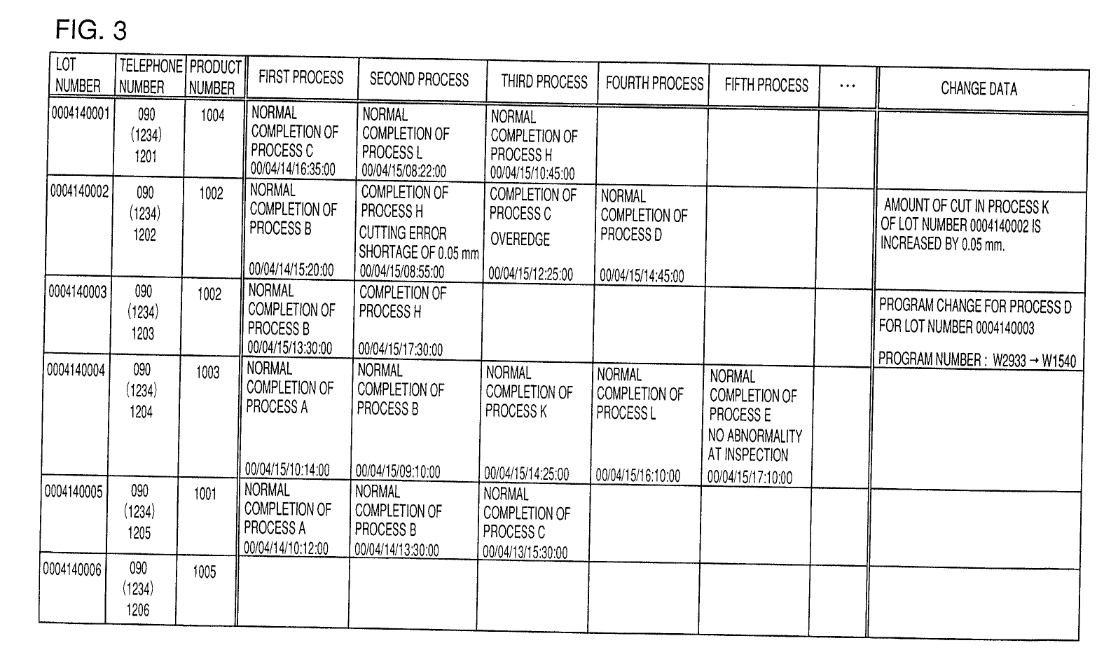

Referring to FIG. 2, process controlling host computer 100 includes: a computer body 102 with an FD (Flexible Disc) driving device 116 and a CD-ROM (Compact Disc-Read Only Memory) driving device 118; a monitor 104; a keyboard 106; a mouse 108; and a portable telephone communication interface 122. In addition to the above mentioned FD driving device 116 and CD-ROM driving device 118, computer body 102 includes; a CPU (Central Processing Unit) 110; a memory 112; a fixed disc 114; and a communication interface 120 connected to network 140 for communicating with operation result inputting computer 102 and production facilities 150 to 156 in the operation process, which are all interconnected by a bus.

CPU 110 can identify an available one of the plurality of production facilities in one operation process based on the information received by communication interface 120 from production facilities 150 to 156 in the operation process.

Portable telephone communication interface 122 calls portable telephone 200 designated by CPU 110. In this case, portable telephone communication interface 102 can call portable telephone 200 using a prescribed one of a predetermined plurality of numbers can uniquely identify portable telephone 200 such as telephone numbers of senders. It is noted that the operation of the computer other than that described above is well known, and therefore detailed description thereof will not be repeated here.

Process controlling host computer 100 performs a progress chasing for every lot based on the information from portable telephone 200 by the above mentioned computer hardware and software executed by CPU 110.

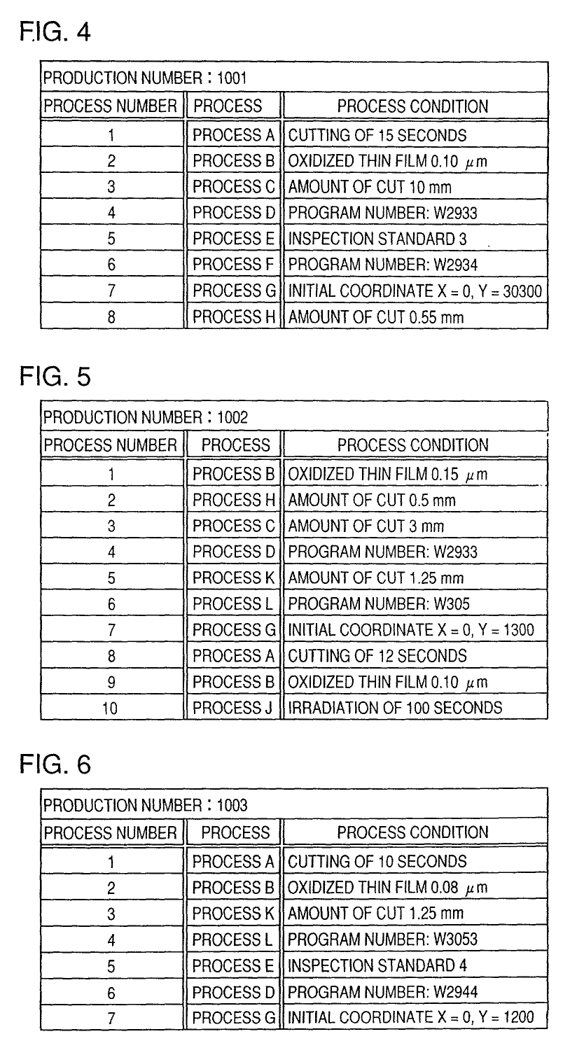

Referring to FIG. 3, a progress chasing table stored in fixed disc 114 of process controlling host computer 100 will be described. As shown in FIG. 3, the progress chasing table stores a number can uniquely identifies portable telephone 200 such as a telephone number of the portable telephone, product number, first to the last processes, and change data for every lot number. For example, stored for the product of a lot number “0004140002” are the product number “1002,” the telephone number of portable telephone 200 attached to that lot. i.e., 090-1234-1202, and the fact that the first to the fourth processes, which are respectively the processes B, H, C and D, have been completed. In addition, stored for the product of a lot number “0004140002” is data indicating that an amount of cut is insufficient (a cutting error) by 0.05 mm in process H, i.e., the second step. Further, change data is stored indicating that the cutting amount must be increased by 0.05 mm in process K, i.e., the fifth step.

The process completion data includes data of the date and time of the process completion. By comparing the completion time of the previous process and the present time based on the date and time of the process completion, a product, if any, that has been left in the process for a long period of time can be detected.

It is noted that the lot number is a combination of numbers and characters that allows the presently manufactured product to be uniquely identified. One product number has a plurality of lot numbers. For the portable telephone, one lot number corresponds to one portable telephone, so that a number can uniquely identifies portable telephone 200 such as a telephone number uniquely identifies the presently manufactured product as in the case of the lot number.

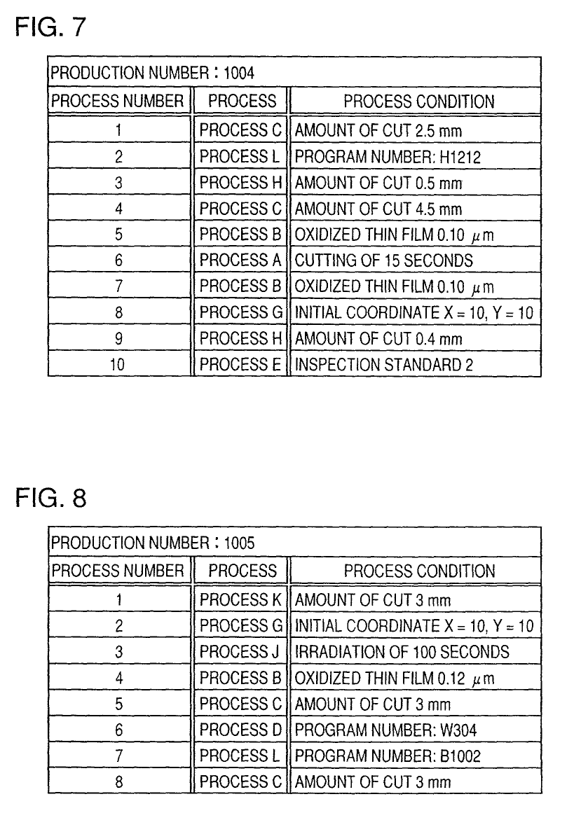

Referring to FIGS. 4 to 8, the operation process data of the product stored in fixed disc 114 of process controlling hot computer 100 will be described. FIGS. 4 to 8 respectively show the operation processes of the products denoted by the product numbers “1001,” “1002,” “1003,” “1004,” and “1005.” For example, for the product of the products number “1001,” shown in FIG. 4, the first process is a process A and a process condition is cutting of 15 seconds. For the process of an oxidized thin film formation, the process condition for the product of the product number “1001” is 0.10 μm (a thickness of an oxidized thin film to be formed). On the other hand, the process conditions for the products of products numbers “1002,” “1003,” “1004,” and “1005” are respectively 0.15 μm, 0.08 μm, 0.10 μm, and 0.12 μm. Thus, the process condition for the product differs for every product number. In such situation, at the production facility in the process of oxidized thin film formation, the process condition must be changed for each product number. In the process of oxidized thin film formation, the products of product numbers “1001” and “1004” having the process condition of 0.10 μm can be successively put into the production facility in the process of oxidized thin film formation. Thus, the process condition at the production facility needs not be changed, so that a processing ability can be enhanced.

The communication device for performing communication with portable telephone 200 is connected to the production facility in the operation process so as to input the process condition and output the operation result. Through the production facility communicating portion of portable telephone 200, which will later be described, the process condition transmitted from host computer 100 to portable telephone 200 can be input to the production facility, and the operation result data from the production facility can be transmitted to portable telephone 200.

If the process condition is changed, change data is stored in a storage region for change data shown in FIG. 5, as previously referenced. The change data indicating the change condition is input with the lot number from process controlling host computer 200.

Except for the absence of a portable telephone communication interface, operation result input computer 102 has the same hardware structure as the above mentioned process controlling host computer 100. When the operation is completed in the operation process, the result data of the operation performed in the completed operation process (for example data such as a measurement value and an inspection result of the product after the operation process is completed) is input by the operator to operation result input computer 102, which in turn transmits the input result data to process controlling host computer 100.

A progress chasing information search computer having the same hardware structure as that of the operation result input computer may be provided in addition to operation result input computer 102. The progress chasing information search computer can search the progress chasing information stored in process controlling host computer 100 based on the lot number or call portable telephone 200 corresponding to the prescribed lot number.

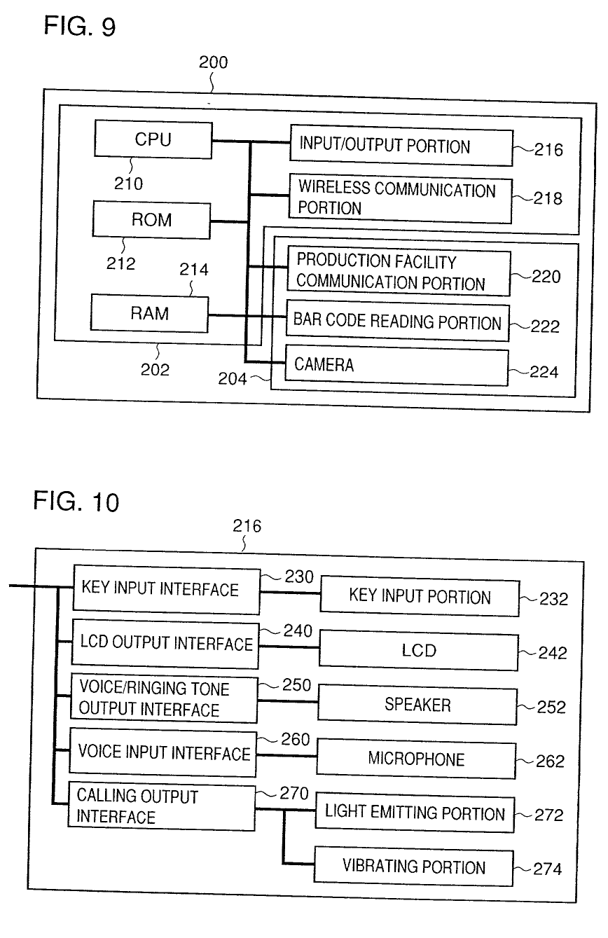

Referring to FIG. 9, portable telephone 200 includes: a basic function portion 202 having a function that a usual portable telephone has; and an added function portion 204 having a function not found in a usual telephone.

Basic function portion 202 includes: a CPU 210 generally controlling portable telephone 200; an ROM (Read Only Memory) 212 storing a program to be executed by CPU 210; an RAM (Random Access Memory) 214 storing an intermediate result of the program executed by CPU 210; an input/output portion 216 receiving an input from a key input portion and displaying a character on an LCD (Liquid Crystal Display); and a wireless communication portion 218 connected to process controlling host computer 100 by wireless communication for communicating data with respect to process controlling host computer 100. CPU 210, ROM 212, RAM 214, input/output portion 216 and wireless communication portion 218 are interconnected by a bus.

It is noted that wireless communication portion 218 receives a number can uniquely identifies portable telephone 200 such as a telephone number of a sender before communication with respect to process controlling host computer 100 is enabled. RAM 214 stores a sender control table storing data types of for example ringing tones for every sender telephone number in order to generate different ringing tones for every sender telephone number, emit different lights for every sender telephone number from a light emitting portion (later described) and generate different vibrations for every sender telephone number from a vibrating portion (later described). The data of ringing tones, emission patterns and vibration patterns are stored in ROM 212.

Added function portion 204 includes: a production facility communication portion 220 transmitting/receiving data indicating the process condition and operation result to/from production facility; a reading portion 222 for reading bar code represented the operation result; and a camera 224 taking image data of the product after the operation result is obtained for transmitting it to RAM 214. Production facility communication portion 220, reading portion 222 and camera 224 are interconnected by a bus connected to CPU 210.

Note that production facility communication portion 220 can be used as wireless communication portion 218 if the production facility has a telephone device.

Added function portion 204 is not necessary if the process condition is not set in the production facility by wireless communication, the operation result is manually input from input/output portion 216 and the image of the completed product is not taken. In the following description, the portable telephone with added function portion 204 will be described.

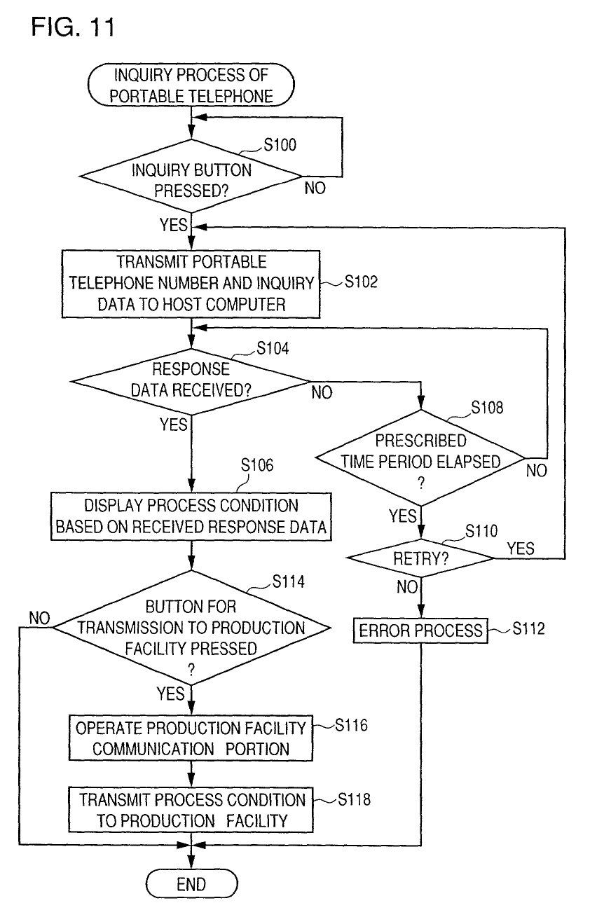

Referring to FIG. 10, input/output portion 216 includes: a key input portion 232 connected to a key input interface 230 and provided on the surface of portable telephone 200; an LCD 242 connected to an LCD output interface for displaying characters, images and the like; a speaker 252 connected to a voice/ringing tone output interface 250 for outputting ringing tones and voices from the party called; a microphone 262 connected to voice input interface 260 for inputting voices of a person; a light emitting portion 272 connected to ringing tone output interface 270 and using an LED (Light Emitting Diode) emitting light with a predetermined pattern and the like; and a vibrating portion 274 for vibrating the portable telephone with a predetermined pattern.

Portable telephone 200 receives the process condition data from process controlling host computer 100 for transmitting it to the production facility, takes the image of the completed product, input the result of operation, and transmits the result data of operation to process controlling host computer 100.

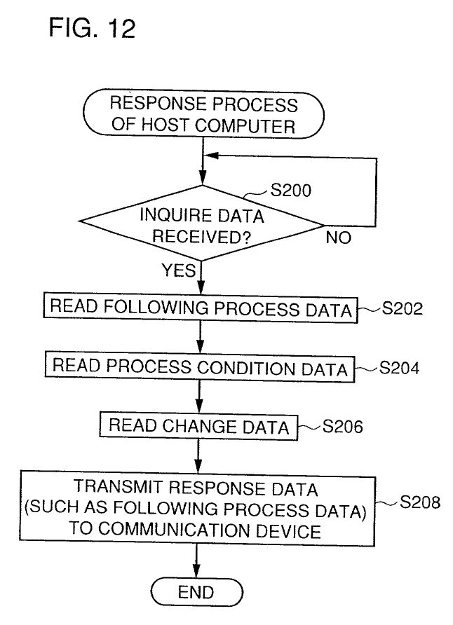

Referring to FIG. 11, a program of an inquiring process executed by portable telephone 200 is performed in the following manner.

At a step 100 (a step is hereinafter abbreviated as S), CPU 210 of portable telephone 200 determines as to if a ten-key of key input portion 232 corresponding to an inquiry button has been pressed. If the corresponding ten-key has been pressed (YES in S100), the process proceeds to an S102. On the other hand, if the corresponding ten-key has not been pressed (NO in S100), the process returns to S100 and waits for the ten-key corresponding to the inquiry button to be pressed.

At S102, CPU 210 of portable telephone 200 transmits the number can uniquely identifies portable telephone 200 such as the telephone number of portable telephone 200 and inquiry data to process controlling host computer 100 through wireless communication portion 218. It is noted that the telephone number of portable telephone 200 is transmitted to portable telephone communication interface 122 of process controlling host computer 100 in a form of a sender telephone number notification.

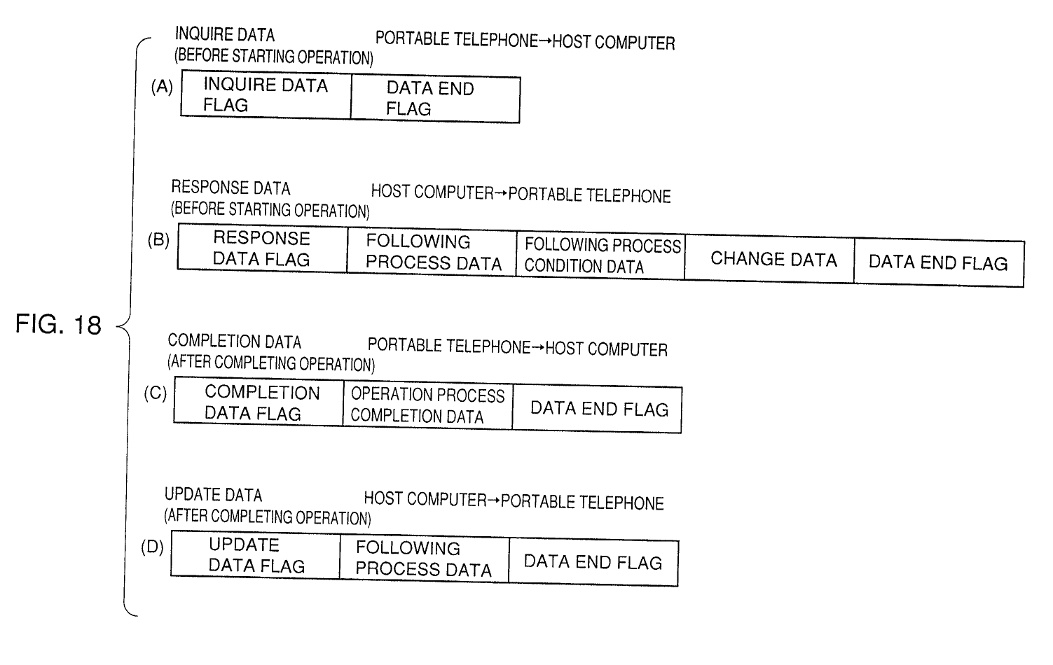

Referring to FIG. 18(A), the inquiry data transmitted from portable telephone 200 to process controlling host computer 100 includes inquiry data flag and data end flag. In addition, as described above, the telephone number of portable telephone 200 which has sent the inquiry data is transmitted to process controlling host computer 100 in the form of sender telephone number notification. Process controlling host computer 100 identifies portable telephone 200 that has transmitted the inquiry data based on the notified telephone number of the sender telephone number notification, and determines that the transmitted data is inquiry data based on the inquiry data flag.

At S104, CPU 210 of portable telephone 200 determines if response data has been received from process controlling host computer 100 through wireless communication portion 218. If the response data has been received from process controlling host computer 100 (YES in S104), the process proceeds to S106. On the other hand, if the response data has not been received from process controlling host computer 100 (NO in S104), the process proceeds to S108.

Referring to FIG. 18(B), the response data transmitted from process controlling host computer 100 to portable telephone 200 includes an response data flag, following process data, following process condition data, change data and data end flag. Note that portable telephone 200 to which the response data is transmitted determines if the transmitted data is response data based on the response data flag.

At S106, CPU 210 of portable telephone 200 displays the following process data, following process condition data and change data on LCD 242 through LCD output interface 240 based on the received response data from process controlling host computer 100. Note that the following process data and the like of the response data is encoded and transmitted from process controlling host computer 100. CPU 210 of portable telephone 200 converts the encoded data to character data using a data conversion table stored in RAM 214. LCD output interface 240 converts the character data to a character image.

At S108, CPU 210 of portable telephone 200 determines if a prescribed period of time is elapsed without receiving the response data from process controlling host computer 100. If a prescribed period of time is elapsed (YES in S108), the process proceeds to S110. On the other hand, if the prescribed period of time is not elapsed (NO in S108), the process returns to S104 and waits for the response data from process controlling host computer 100.

At S110, CPU 210 of portable telephone 200 determines if the inquiry data is again to be transmitted to process controlling host computer 100. The determination is made for example by preliminary storing a retry frequency in RAM 214, counting the frequency of inquiry data transmission processes in S102, and comparing the counted transmission frequency with the retry frequency. If it is determined that transmission is retried (YES in S110), the process returns to S102 and retries transmission of the inquiry data to process controlling host computer 100. On the other hand, if it is determined that transmission is not to be retried (NO in S110), the process proceeds to S112.

At S112, CPU 210 of portable telephone 200 displays that the response data cannot be received from process controlling host computer 100 on LCD 242 to end the process.

At S114, after receiving the response data (YES in S104) and the process condition and the like are displayed on LCD 242 (S106), CPU 210 of portable telephone 200 determines if the ten-key of key input portion 232 corresponding to an input button for transmitting a process condition to the production facility has been pressed. If the corresponding ten-key has been pressed (YES in S114), the process proceeds to S116. On the other hand, if the ten-key corresponding to the input button for transmitting process condition has not been pressed (NO in S114), the process ends.

At S116, CPU 210 of portable telephone 200 operates production facility communication portion 220. Production facility communication portion 220 is operated only when the ten-key corresponding to the input button for transmitting process condition has been pressed to save an electric power of a rechargeable battery in portable telephone 200.

CPU 210 of portable telephone 200 transmits the process condition data and change data that have been received in S104 to the production facility through production facility transmitting portion 220. Thereafter, CPU 210 of portable telephone 200 stops operation of production facility communication portion 220.

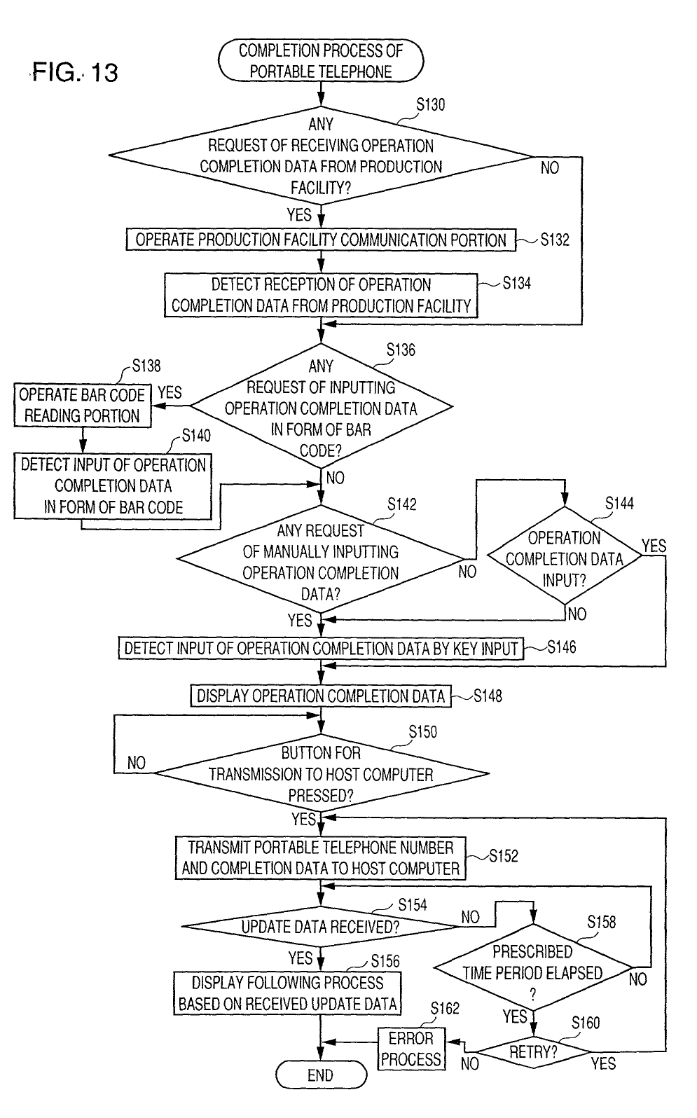

Referring to FIG. 12, the responsing process of the program executed by process controlling host computer 100 is performed in the following manner.

At S200, CPU 110 of process controlling host computer 100 determines if the inquiry data (data shown in FIG. 18(A)) including an inquiry data flag has been received from any of portable telephones 200. If the inquiry data has been received from any of portable telephones 200 (YES in S220), the process proceeds to S202. On the other hand, if the inquiry data has not been received (NO in S200), the process returns to S200 and waits for the inquiry data from any of portable telephones 200 to be received.

At S202, CPU 110 of process controlling host computer 100 reads the production number and the following process data for the lot number identified by the telephone number based on the telephone number of the received sender telephone number notification and the progress chasing table (a table shown in FIG. 3) stored in fixed disc 114. For example, if the telephone number received as the sender telephone number notification is 090-1234-1203, the product with that portable telephone 200 has a lot number “0004140003” and a product number “1002.” In this case, since a step H, i.e., the second step, has been completed, a step C, i.e., the third step, will be the subject of the following step data based on the operation process data (shown in FIGS. 6 to 10).

At S204, CPU 110 of process controlling host computer 100 reads the process condition data of the following process from the operation process data (data shown in FIGS. 6 to 10) based on the product number and the process data read in S202. In the case of the lot number of the above mentioned “000410003,” an amount of cut of 3 mm is read for the process condition of the step C, i.e., the third process.

In S206, CPU 110 of process controlling host computer 100 reads change data corresponding to the received lot number from the progress chasing table. Then, in the case of the lot number of the above mentioned “000410003,” change data reading “changed from program number W2933 to W1540 of a process D” is read.

At S208, CPU 110 of process controlling host computer 110 transmits response data, including the following process data read in S202, the process condition data of the following process read in S204 and change data read in S206, to portable telephone 200 identified by the received telephone number of the sender telephone number notification. The transmitted response data is shown in FIG. 18 (B) as described above.

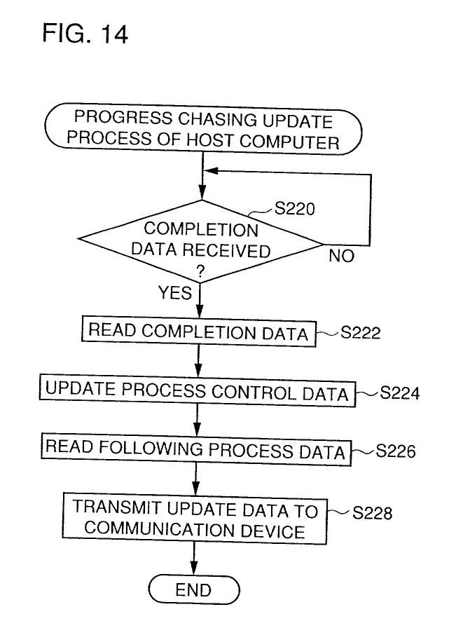

Referring to FIG. 13, the operation completing process of the program executed by portable telephone 200 is performed in the following manner.

At S130, CPU 210 of portable telephone 200 determines if there is a request of receiving operation completion data from the production facility. The determination is made base on whether the ten-key of key input portion 232 corresponding to the operation completion data receiving request button has been pressed or not. If the corresponding ten-key has been pressed (YES in S130), the process proceeds to S132. On the other hand, if the ten-key corresponding to the inquiry button has not been pressed (NO in S130), the process proceeds to S136.

At S132, CPU 210 of portable telephone 200 operates production facility communication portion 220. As in the above described case, production facility communication portion 220 is operated only when the ten-key corresponding to the operation completion data receiving request button is pressed to save an electric power of a rechargeable battery in portable telephone 200.

At S134, CPU 210 of portable telephone 200 receives the operation completion data from the production facility. The received operation completion data is stored in RAM 214. Thereafter, CPU 210 of portable telephone 200 stops operation of production facility communication portion 220.

At S136, CPU 210 of portable telephone 200 determines if there is a request of inputting the operation completion data by a bar code. The determination is made based on whether the ten-key of key input portion 232 corresponding to the bar code input request button has been pressed or not. If the corresponding ten-key has been pressed (YES in S136), the process proceeds to S138. On the other hand, if the ten-key corresponding to the bar code input request button has not been pressed (NO in S136), the process proceeds to S142.

At S138, CPU 210 of portable telephone 200 operates a bar code reading portion 222. As in the above described case, bar code reading portion 222 is operated only when the ten-key corresponding to the bar code input request button has been pressed to save an electric power of the rechargeable battery in portable telephone 200.

At S140, CPU 210 of portable telephone 200 detects input of the operation completion data by bar code reading portion 222. For example, the operation completion data represented by the bar code is data indicating, “normal end.” The detected operation completion data is stored in RAM 214. Thereafter, CPU 210 of portable telephone 200 stops operation of bar code reading portion 222.

At S142, CPU 210 of portable telephone 200 determines if there is a request of manually inputting the operation completion data. The determination is made based on whether the ten-key of key input portion 232 corresponding to the manual input request button has been pressed or not. If the corresponding ten-key has been pressed (YES in S142), the process proceeds to S146. On the other hand, if the ten-key corresponding to the manual input request button has not been pressed (NO in S142), the process proceeds to S144.

At S144, CPU 210 of portable telephone 200 determines if the operation completion data has been input. The determination is made based on whether the operation completion data input in S134 or S140 has been stored in RAM 202. If the operation completion data has been input (YES in S144), the process proceeds to S148. On the other hand, if it is determined that the operation completion data has not been input (NO in S144), the process proceeds to S146.

At S146, CPU 210 of portable telephone 200 detects input of the operation completion data from key input portion 232. The detected operation completion data is stored in RAM 214. At the time, camera 224 is used to pick up the image of the product after the operation has been completed, and the taken image data can be added to the operation completion data.

At S148, CPU 210 of portable telephone 200 displays the operation completion data on LCD 242, which has been input in one of S134, S140 and S146 and stored in RAM 214.

At S150, CPU 210 of portable telephone 200 determines if the ten-key of key input portion 232 corresponding to the button for transmitting the completion data to process controlling host computer 100 has been pressed. If the corresponding ten-key has been pressed (YES in S150), the process proceeds to S152. On the other hand, if the corresponding ten-key has not been pressed (NO in S150), the process returns to S150 and waits for the ten-key corresponding to the completion data transmission pattern to be pressed.

At S152, CPU 210 of portable telephone 200 transmits the number can uniquely identifies portable telephone 200 such as the telephone number of portable telephone 200 and completion data to process controlling host computer 100 through wireless communication portion 218. It is noted that the telephone number of portable telephone 200 is transmitted to portable telephone communication interface 122 of process controlling host computer 100 in a form of sender telephone number notification.

Referring to FIG. 18 (C), the completion data transmitted to process controlling host computer 100 from portable telephone 200 includes a completion data flag, operation process completion data, and data end flag. The operation process completion data includes the operation completion data received from the production facility, image data of the product which has been taken by camera 224, and the like. In addition to the completion data, the telephone number of portable telephone 200 which sent the completion data is transmitted to process controlling host computer 100 in the form of sender telephone number notification. Process controlling host computer 100 identifies process controlling device 200 which sent the completion data by the telephone number notified by the sender telephone number notification, and determines if the transmitted data is the completion data based on the completion data flag.

At S154, CPU 210 of portable telephone 200 determines if update data has been received from process controlling host computer 100. If the update data has been received from process controlling host computer 100 (YES in S154), the process proceeds to S156. On the other hand, if the update data has not been received from process controlling host computer 100 (NO in S154), the process proceeds to S158.

Referring to FIG. 18(D), the update data transmitted from process controlling host computer 100 to portable telephone 200 includes an update data flag, following process data, and data flag. A communication header includes a destination terminal flag and update data end flag. It is noted that portable telephone 200 to which the update data is transmitted determines if the transmitted data is the update data based on the update data flag.

At S156, CPU 210 of portable telephone 200 extracts the following process data from the update data received from process controlling host computer 100 in S154 for display onto LCD 242.

At S158, CPU 210 of portable telephone 200 determines if a prescribed period of time is elapsed without receiving any update data from process controlling host computer 100. If the prescribed period of time is elapsed (YES in S158), the process proceeds to S160. On the other hand, if the prescribed period of time is not elapsed (NO in S158), the process returns to S154 and waits for the update data to be received from process controlling host computer 100.

At S160, CPU 210 of portable telephone 200 determines if transmission of the completion data to process controlling host computer 100 is again to be performed. The determination is made by preliminary storing the retry frequency in RAM 214, counting the frequency of completion data transmission processes in S152, and comparing the counted transmission frequency with the retry frequency as in the process of the above described S110. If the transmission is determined to be retried (YES in S150), the process returns to S152 and transmits again the completion data to process controlling host computer 100. On the other hand, if retry of transmission is not determined (NO in S150), the process proceeds to S162.

At S162, CPU 210 of portable telephone 200 displays on LCD 242 the fact that the update data cannot be received from process controlling host computer 100 through LCD output interface 240 to end the process.

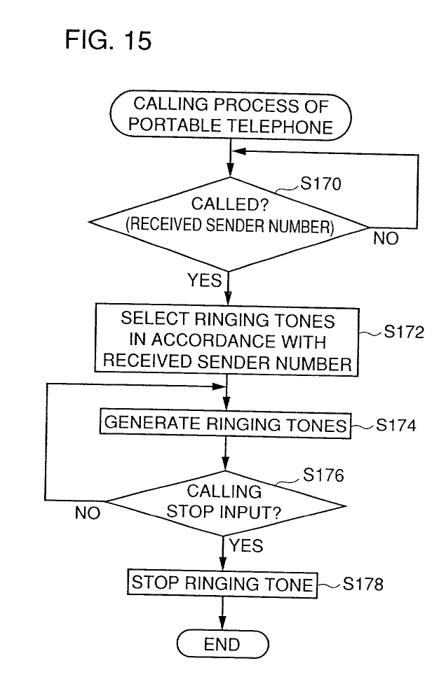

Referring to FIG. 14, a progress chasing update process of the program executed by process controlling host computer 100 is performed in the following manner.

At S220, CPU 110 of process controlling host computer 100 determines if the completion data has been received from portable telephone 200. If the completion data has been received (YES in S220), the process proceeds to S222. On the other hand, if the completion data has not been received (NO in S220), the process returns to S220 and waits for the completion data to be received from portable telephone 200.

At S222, CPU 110 of process controlling host computer 100 reads the completion data received in S220. At S224, CPU 110 of process controlling host computer 100 updates the process controlling data of the progress chasing table stored in fixed disc 114. As shown in FIG. 3, for example, if the telephone number received as the sender telephone number notification is 090-1234-1205, the lot number of the product with portable telephone 200 is “000410005” and the product number is “1001.” If the completion data has been received, the completion of a process D, i.e., the fourth process, is stored in the progress chasing table. More specifically, the time at which the completion data has been received and the transmitted completion data are stored in the progress chasing table.

At S232, CPU 110 of process controlling host computer 100 transmits the following process data read in S226 to portable telephone 200 having the telephone number received by the sender telephone number notification. The transmitted update data is shown in FIG. 18(D) as described above.

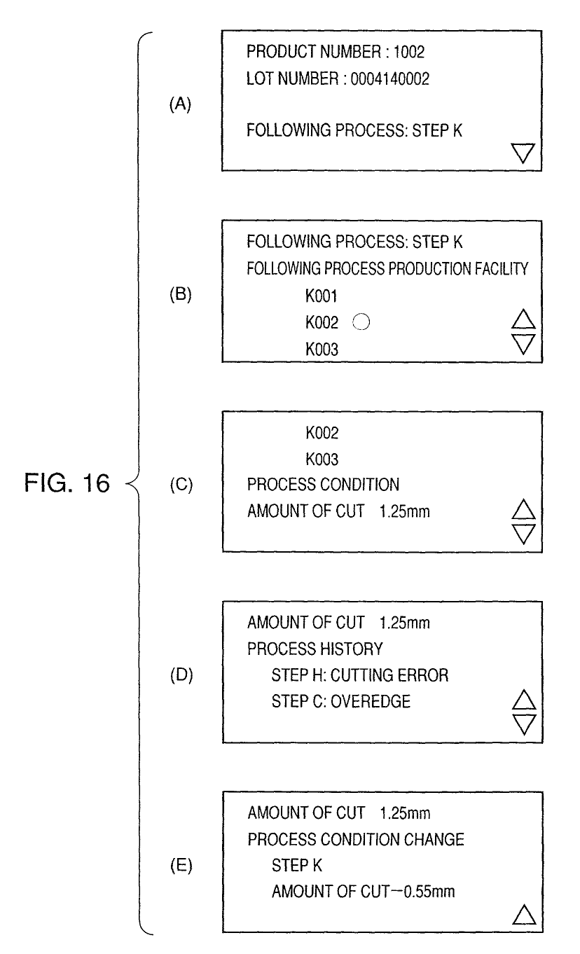

Referring to FIG. 15, the calling process of the program executed by portable telephone 200 is performed in the following manner.

At S170, CPU 210 of portable telephone 200 determines if it is called by process controlling host computer 100 through wireless communication portion 218. If it is called by the process controlling host computer (YES in S170), the process proceeds to S172. If not (NO in S170), the process returns to S170 and waits until portable telephone 200 is called by the process controlling host computer.

At S172, CPU 210 of portable telephone 200 selects ringing tones based on the number can uniquely identifies portable telephone 200 such as the sender telephone number received from process controlling host computer 100 through wireless communication portion 218. The selection is based on data stored in the sender control table in RAM 214. It is noted that, as stated previously, portable telephone communication interface 122 of process controlling host computer 100 can switch among a plurality of sender telephone numbers for calling portable telephone 200. For example, referring to FIG. 3, in calling portable telephones 200 attached to the products having product numbers “1001” and “1002,” these two different product numbers are distinguished for calling. For portable telephone 200 attached to the product having the product number “1001” and lot number “000410005,” the sender telephone number notification is performed by the number of 03-1234-1234. On the other hand, for portable telephones 200 attached to the products having the product number “1002,” the lot numbers “0004140002” and “0004140003, ” the sender telephone number notification is performed by the number 03-1234-1235. The types of ringing tones generated in accordance with the telephone number received by the sender telephone number notification are stored in RAM 214.

At S174, CPU 210 of portable telephone 200 generates ringing tones in accordance with the sender telephone number notification from speaker 252. Then, light emitting portion 272 may emit light with a predetermined pattern and vibrating portion 274 may vibrate with a predetermined pattern.

At S176, CPU 210 of portable telephone 200 determines if the ten-key of key input portion 232 corresponding to a ringing tone stop request button has been pressed. If the corresponding ten-key has been pressed (YES in S176), the process proceeds to S152. If not (NO in S176), the process returns to S174 and CPU 210 of portable telephone 200 continues to generate ringing tones corresponding to the sender telephone number notification from speaker 252.

At S178, CPU 210 of portable telephone 200 stops to generate the ringing tones, thereby ending the process.

The operation of portable telephone 200 based on the above described structure and the flow charts will be described.

Inquiring Process of Portable Telephone

In portable telephone 200 attached to the product, if the ten-key of key input portion 232 corresponding to the inquiry button is pressed (YES in S100), the inquiry data shown in FIG. 18(A) is transmitted to process controlling host computer 100 (S102). At the time, the telephone number of portable telephone 200 is transmitted to process controlling host computer 100 by the sender telephone number notification.

In process controlling host computer 100, if the inquiry data is received (YES in S200), the following process data is read from the progress chasing table shown in FIG. 3 for the product corresponding to the lot number designated by the telephone number received from the sender telephone number notification (S202). The process condition data of the following process is read from the operation process data shown in FIGS. 6 to 10 for the product corresponding to the lot number designated by the telephone number (S204). The corresponding change data is read from the progress chasing data shown in FIG. 3 (S206). Process controlling host computer 100 transmits the following process data read in S202 to S206 as response data to portable telephone 200 having the telephone number received from the sender telephone number notification.

In portable telephone 200, if the response data is received from process controlling host computer 100 (YES in S104), the name of the following process and the process condition of the following process are displayed on LCD 242 based on the response data including for example the following process data, following process condition data and the like shown in FIG. 18(B) (S106).

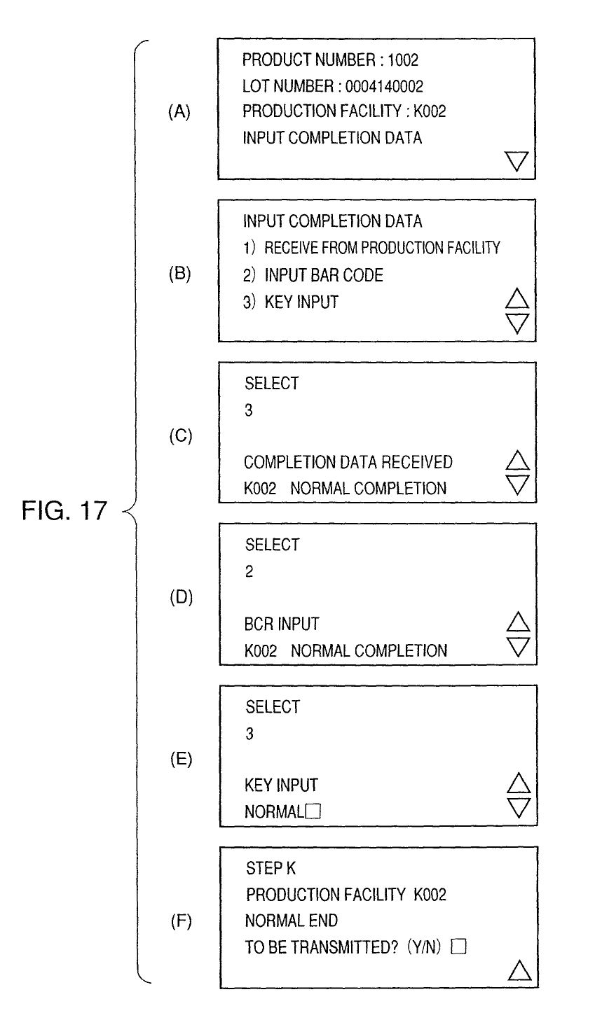

FIGS. 16(A) to (E) show exemplary display screens of LCD 242 of portable telephones 200 attached to the product having the product number “1002” and the lot number “04140002.” As shown in FIG. 16(A), a process K is displayed on LCD 242 as the following process. If there is any data outside the visible range of the screen of LCD 242, a scroll key is displayed. When the key of key input portion 232 corresponding to the scroll key is pressed, a display content changes as shown in FIGS. 16(B) to (E). Referring to FIG. 16(B), in LCD 242, a mark ◯ is displayed at available production facility K002 among production facilities K001, K002 and K003 at the following process K. The operator puts the lot to production facility K002 at the process K in accordance with the display content.

Further, if the key of key input portion 232 corresponding to the scroll key is pressed, LCD 242 displays the process condition of the following process K of the lot as shown in FIG. 16(C), displays the result of an operation at the process in which the operation on the lot has been completed as shown in FIG. 16(D), or displays the change process condition of the lot as shown in FIG. 16(E). Referring to FIGS. 16(B) to (D), upward and downward scroll keys are displayed and, if the keys of key input portion 232 corresponding to respective scroll keys are pressed, the screen scrolls in an upward or downward direction. Further, as shown in FIG. 16(E), an upward scroll key is displayed and, if the key of key input portion 232 corresponding to that scroll key is pressed, the screen scrolls in the upward direction.

In portable telephone 200, after the following process condition or the like is displayed on LCD 242, if the ten-key of key input portion 232 corresponding to the input button for transmitting process condition is pressed (YES in S114), production facility communication portion 220 operates and the process condition is transmitted to the production facility (S118). For example, in the case of the lot shown in FIG. 16, transmitted to production facility K002 in the process K are an amount of cut of 1,25 mm and the change data of the process condition (the amount of cut is increased by 0.05 mm in the process K). In production facility K002, the operation is performed on the lot under the process condition of the amount of cut of 1.30 (1.25+0.05) mm. It is noted that the process condition may be created in consideration of the change condition in portable telephone 200 for transmitting it to the production facility.

On the other hand, if the prescribed period of time is elapsed without receiving the response data (NO in S104, YES in S108), the inquiry data is transmitted again to process controlling host computer 100 until the transmission frequency of the inquiry data exceeds the predetermined retry frequency (YES in S110). If the transmission frequency of the inquiry data exceeds the retry frequency (YES in S110), an error indicating that the response data cannot be received from process controlling host computer 100 is displayed on LCD 242 of portable telephone 200.

[Operation Completing Process of Portable Telephone]

When the process on the product is completed in a certain process, as shown in FIGS. 17(A) and 17(B), an input screen of the operation completion data is displayed on LCD 242. Referring to FIG. 17(C), if the ten-key of key input portion 232 corresponding to the operation completion data receiving request pattern of portable telephone 200 is pressed (YES in S130), production facility communication portion 220 operates (S132) and the operation completion data is received from the production facility (S134). Further, as shown in FIG. 17(D), if the ten-key of key input portion 232 corresponding to the bar code input request button of portable telephone 200 is pressed (YES in S136), bar code reading portion 222 operates (S138) and the bar code representing the operation completion data is scanned to input the operation completion data (S134). Further, as shown in FIG. 17(E), if ten-key input portion 232 corresponding to the manual input request button of portable telephone 200 is pressed (YES in S142), input from key input portion 232 is enabled and the operator inputs the operation completion data (S146). Further, the image of the product after the completion of the operation is taken by camera 224, and the taken image data is added to the operation completion data.

As shown in FIG. 17(F), the operation completion data is displayed on LCD 242 of portable telephone 200 (S148) and, if the ten-key of key input portion 232 corresponding to the completion data transmission button is pressed (YES in S150), the completion data as shown in FIG. 18(C) is transmitted from portable telephone 200 to process controlling host computer 100 (S152).

In process controlling host computer 100, if the completion data is received (YES in S220), the completion data is read (S222) and the process control data of the progress chasing table as shown in FIG. 3 is updated (S224). The following process data of the operation process designated by the completion data is read (S226), and the update data as shown in FIG. 18(D) is transmitted to portable telephone 200 that transmitted the completion data (S228).

In portable telephone 200, if the update data is received from process controlling host computer 100 (YES in S154), the following process is displayed on LCD 242 based on the following process data of the update data shown in FIG. 18(D) (S156).

On the other hand, if a prescribed period of time is elapsed without receiving any update data (NO in S154, YES in S158), transmission of the completion data to process controlling host computer 100 is repeated until the transmission frequency of the completion data exceeds the predetermined retry frequency (YES in S160). If the transmission frequency of the completion data exceeds the retry frequency (NO in S160), an error indicating that the update data cannot be received from process controlling host computer 100 is displayed on LCD 242 of portable telephone 200 (S162).

[Calling Process of Portable Telephone]

When a product to be called by process controlling host computer 100 is designated, portable telephone communication interface 122 changes the number can uniquely identifies portable telephone 200 such as the sender telephone number for every product number, so that portable telephone 200 attached to the lot of the target product is called. In the following, for example, an operation of calling the portable telephone will be described when portable telephones 200 attached to the lot with product numbers 1001 and 1002 as shown in FIG. 3. In this case, portable telephone communication interface 122 of process controlling host computer 100 performs the sender telephone number notification by 03-1234-1234 on portable telephone 200 attached to the product with the lot number “0004140005”, the product number “1001.” For the product with the lot numbers “000410002” and “0004140003,” the product number “1002,” the sender telephone number notification is performed by 03-1234-1235.

If portable telephone 200 is called by process controlling host computer 100 (YES in S170), ringing tones in accordance with the sender telephone number notification received from the sender control table in RAM 214 is selected (S172), so that the selected ringing tones are generated from speaker 252 (S174). At the time, in two portable telephones attached to the products with the lot numbers “0004140002” and “0004140003,” the product number “1002,” the same ringing tones are output. In the portable telephones attached to the products with the lot number “0004140005,” the product number “1001,” ringing tones different from those output of the above described two portable telephones are output. Thus, the operator can find the products with a prescribed lot number in the process, and find the products with the same production number collectively in the process.

As described above, according to the process control method of the present embodiment, the portable telephone attached to every lot communicates with the process controlling host computer for receiving the following process data and the process condition data from the process controlling host computer to display the following process and the process condition of the following process onto the LCD or setting the process condition in the production facility. Further, the product can be designated by the process controlling host computer to generate ringing tones of the portable telephone attached to the lot of the product. Consequently, a process control method can be provided which enables the operator to easily recognize the following process of the product in the production process, easily set the process condition, and easily find a desired product in the production process.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A product control method of controlling processes of producing said product by wireless communication between a communication device attached to said product and a computer controlling said process of producing said product, comprising the steps of:
preparing in said computer a control table storing control data controlling said product corresponding to an identification number for identifying said communication device;
transmitting said identification number and information requiring control data from said communication device to said computer by wireless communication;
transmitting, from said computer to said communication device identified by said identification number, control data stored in said control table corresponding to said received identification number in response to reception of said identification number and said information requiring control data from said communication device;
receiving in said communication device said control data from said computer; and
outputting control data relating to said product in a form recognizable to a person based on said received control data.

2. The product control method according to claim 1, wherein said control data include progress chasing information on said product in said processes and process condition data in said processes, and
said step of outputting said control data includes the step of outputting process condition data in a following process of said product in the form recognizable to the person.

3. The product control method according to claim 2, wherein said product control method further includes the step of transmitting said process condition data to a production facility for producing said product by wireless communication from said communication device.

4. The product control method according to claim 1, wherein said control data includes operation results at said producing process, and
said step of outputting said control data includes the step of outputting in said communication device said operation results in the form recognizable to the person.

5. The product control method according to claim 1, further comprising the step of transmitting operation results at said process from said communication device to said computer.

6. The product control method according to claim 5, further comprising the step of receiving said operation results from said production facility by wireless communication in said communication device.

7. The product control method according to claim 5, wherein said communication device attached to said product is a communication device having a bar code reading device, bar code indicated a plurality of operation results is prepared in said process, and said product control method further includes the step of reading said bar code selected by the operator.

8. The product control method according to claim 5, further comprising the step of taking an image of said product after said operation in said process, wherein said result data is image data, in said image taking step, representing a product after the operation.

9. The product control method according to claim 8, wherein said communication device attached to said product is a portable telephone device having an image pickup device, and said step of taking an image of said product after said operation includes the step of taking an image of said product after said operation in said process using said image pickup device of said portable telephone device.

10. The product control method according to claim 1, wherein said communication device attached to said product is a portable telephone device.

11. A product control method of controlling process of producing said product by a communication device attached to said product and a computer controlling said process of producing said product by wireless communication, comprising the steps of:
preparing in said computer registration data of said product corresponding to an identification number for identifying said communication device;
selecting said product stored in said registration data;
transmitting calling data from said computer to said communication device designated by said identification number corresponding to said product selected in said step of selecting said product; and
performing a prescribed operation in said communication device identified by said calling data based on said received calling data in response to reception of said calling data from said computer.

12. The product control method according to claim 11, wherein said registration data is data of said products divided into a plurality of groups,
said step of selecting said product includes the step of selecting one of said plurality of groups, and
said step of transmitting calling data includes the step of transmitting first calling data from said computer to said communication device identified by said identification number corresponding to the products included in said one group.

13. The product control method according to claim 12, wherein said step of transmitting said calling data includes the step of transmitting first calling data from said computer to said communication device identified by said identification number corresponding to said product included in said one group.

14. The product control method according to claim 12, wherein said step of selecting said product further includes the step of selecting another group, other than said one group, among said plurality of groups,
said step of transmitting said calling data further includes the step of transmitting second calling data from said computer to said communication device identified by said identification number corresponding to the product included in said another group, and
said step of performing said prescribed operation includes the step of selectively performing first and second operations based on a fact that said calling data is said first or second calling data in response to reception of said calling data from said computer.

15. The product control method according to claim 11, wherein said communication device attached to said product is a portable telephone device, and said prescribed operation outputs ringing tones of said portable telephone device from a speaker.
